(19) United States
(12) Patent Application Publication
(10) Pub. No.: US 2018/0270428 A1
(43) Pub. Date: Sep. 20, 2018

(54) ELECTRONIC INFORMATION BOARD SYSTEM, IMAGE PROCESSING DEVICE, AND IMAGE PROCESSING METHOD

(71) Applicants: Masaki NOSE, Kanagawa (JP); Koji Kuwata, Kanagawa (JP); Nobumasa Gingawa, Kanagawa (JP); Masaaki Ishikawa, Kanagawa (JP)

(72) Inventors: Masaki NOSE, Kanagawa (JP); Koji Kuwata, Kanagawa (JP); Nobumasa Gingawa, Kanagawa (JP); Masaaki Ishikawa, Kanagawa (JP)

(21) Appl. No.: 15/911,295

(22) Filed: Mar. 5, 2018

(30) Foreign Application Priority Data
Mar. 17, 2017 (JP) 2017-052342

(51) Int. Cl. H04N 5/272; G06K 9/00; H04N 5/262; H04N 7/15

(52) U.S. Cl. CPC H04N 5/272; H04N 7/15; H04N 5/2628; G06K 9/00255

(57) ABSTRACT

An image processing device includes circuitry to acquire a first image and a second image captured from different viewpoints, detect areas of faces of a plurality of persons in the first image and the second image, set a position of a boundary between the first image and the second image in one of intervals between the detected areas of the faces of the plurality of persons, and combine the first image and the second image at the position of the boundary.

### CROSS-REFERENCE TO RELATED APPLICATION

This patent application is based on and claims priority pursuant to 35 U.S.C. § 119(a) to Japanese Patent Application No. 2017-052342 filed on Mar. 17, 2017, in the Japan Patent Office, the entire disclosure of which is hereby incorporated by reference herein.

### BACKGROUND

### Technical Field

The present invention relates to an electronic information board system, an image processing device, and an image processing method.

### Description of the Related Art

An electronic information board system to which a user inputs information such as a character by performing an interactive input operation on a display board has been used in companies, educational institutions, and administrative agencies, for example. The electronic information board system is also referred to as an interactive whiteboard (IWB) or an electronic whiteboard, for example.

Recent years have seen a spread of a technology of capturing an image with a camera installed to, for example, an upper part of the display board of the electronic information board system, and transmitting and receiving the image between a plurality of electronic information board systems to enable a videoconference between remote sites.

The existing technique, however, has difficulty in communicating the situation of participants of the videoconference to other participants of the videoconference at another site when the participants of the videoconference spread over a relatively wide viewing angle as viewed from the electronic information board system, for example.

### SUMMARY

In one embodiment of this invention, there is provided an improved image processing device that includes, for example, circuitry to acquire a first image and a second image captured from different viewpoints, detect areas of faces of a plurality of persons in the first image and the second image, set a position of a boundary between the first image and the second image in one of intervals between the detected areas of the faces of the plurality of persons, and combine the first image and the second image at the position of the boundary.

In one embodiment of this invention, there is provided an improved electronic information board system that includes, for example, a board, a first camera, a second camera, and at least one processor. The first camera captures a first image of a space in front of the board from a first viewpoint. The second camera captures a second image of the space in front of the board from a second viewpoint different from the first viewpoint. The at least one processor acquires the first image and the second image, detects areas of faces of a plurality of persons in the first image and the second image, sets a position of a boundary between the first image and the second image in one of intervals between the detected areas of the faces of the plurality of persons, and combines the first image and the second image at the position of the boundary.

In one embodiment of this invention, there is provided an image processing method including acquiring a first image and a second image captured from different viewpoints, detecting areas of faces of a plurality of persons in the first image and the second image, setting a position of a boundary between the first image and the second image in one of intervals between the detected areas of the faces of the plurality of persons, and combining the first image and the second image at the position of the boundary.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an information processing system according to a first embodiment of the present invention;

FIG. 2 is a diagram illustrating an example of a hardware configuration of an interactive whiteboard (IWB) in the information processing system according to the first embodiment;

FIG. 3 is a diagram illustrating an example of functional blocks of an image processing device of the IWB according to the first embodiment;

FIG. 4 is a sequence chart illustrating an example of processing of the information processing system according to the first embodiment;

FIGS. 5A to 5D are diagrams illustrating an image synthesizing process according to the first embodiment;

FIG. 6 is a flowchart illustrating an example of the image synthesizing process;

FIGS. 7A and 7B are diagrams illustrating a projective transformation process according to the first embodiment;

FIGS. 8A and 8B are diagrams illustrating a process of determining a seam of images according to the first embodiment;

FIG. 9 is a diagram illustrating an example of an image synthesized from laterally aligned images;

FIG. 10 is a diagram illustrating an example of an image synthesized from laterally aligned images not subjected to projective transformation and height adjustment;

FIGS. 11A to 11D are diagrams illustrating an image synthesizing process according to a second embodiment of the present invention;

FIGS. 12A to 12D are diagrams illustrating an image synthesizing process according to a third embodiment of the present invention;

FIG. 13 is a diagram illustrating an example of a hardware configuration of an IWB according to a fourth embodiment of the present invention;

FIG. 14 is a diagram illustrating an example of functional blocks of an image processing device of the IWB according to the fourth embodiment;

FIG. 15 is a flowchart illustrating an example of a process of displaying a zoomed-in image of a speaker according to the fourth embodiment;

FIG. 16 is a diagram illustrating a process of estimating the direction of the speaker according to the fourth embodiment;

FIG. 17 is a diagram illustrating an example of a screen displaying the zoomed-in image of the speaker;

FIG. 18 is a diagram illustrating an example of a hardware configuration of an IWB according to a fifth embodiment of the present invention;

FIG. 19 is a flowchart illustrating an example of an image switching process according to the fifth embodiment;

FIGS. 20A and 20B are diagrams illustrating a process of switching an image to be transmitted according to the fifth embodiment;

FIG. 21 is a diagram illustrating an example of synthesizing images from three cameras; and

FIG. 22 is a diagram illustrating an example of synthesizing predetermined images into detected face areas.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the accompanying drawings, wherein like reference numerals designate identical or corresponding parts throughout the several views, embodiments of the present invention will be described in detail.

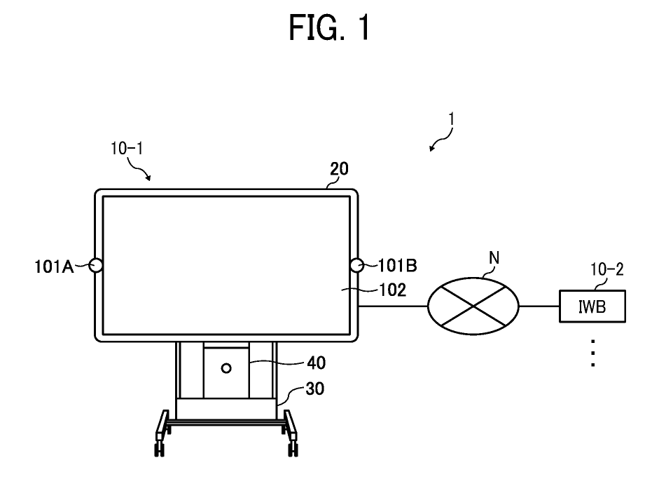

With reference to FIG. 1, a system configuration of a communication system 1 (i.e., an information processing system) according to a first embodiment of the present invention will first be described.

FIG. 1 is a diagram illustrating an example of the system configuration of the communication system 1 according to the first embodiment.

As illustrated in FIG. 1, the communication system 1 according to the first embodiment includes a plurality of interactive whiteboards (IWBs) 10-1, 10-2, and so forth (hereinafter simply referred to as the IWBs 10 where distinction therebetween is unnecessary). The IWBs 10 are mutually communicably connected via a network N such as the Internet or a wired or wireless local area network (LAN).

Each of the IWBs 10 includes cameras 101A and 101B, a panel unit 20, a stand 30, and an image processing device 40.

The cameras 101A and 101B are installed at a given height on the right side and the left side of the panel unit 20, respectively. Further, the cameras 101A and 101B are installed in a direction in which the cameras 101A and 101B are able to capture the image of a person seated at a table placed in front of the IWB 10 at a position farthest from the IWB 10. The cameras 101A and 101B may be installed in a direction in which only the image of the person at the farthest position is captured by both the cameras 101A and 101B in an overlapping manner.

The panel unit 20 is a flat panel display employing a system such as a liquid crystal system, an organic light emitting (LE) system, or a plasma system. A touch panel 102 is installed on the front surface of a housing of the panel unit 20 to display an image.

The stand 30 supports the panel unit 20 and the image processing device 40. The stand 30 may be omitted from the configuration of the IWB 10.

The image processing device 40 displays on the panel unit 20 information such as a character or a figure written at a coordinate position detected by the panel unit 20. The image processing device 40 further synthesizes the image captured by the camera 101A and the image captured by the camera 101B, and transmits a resultant synthesized image to the other IWBs 10. Further, the image processing device 40 displays on the panel unit 20 images received from the other IWBs 10.

The IWB 10-1 transmits and receives information such as still or video images of the cameras 101A and 101B, sounds, and renderings on the panel unit 20 to and from the other IWBs 10 including the IWB 10-2 to have a videoconference with the other IWBs 10.

As compared with an existing projector serving as an image display system, the IWB maintains image quality and visibility even in a bright room, provides easy interactive function such as pen input function, and does not cast a shadow of a person standing in front of a display screen unlike the projector.

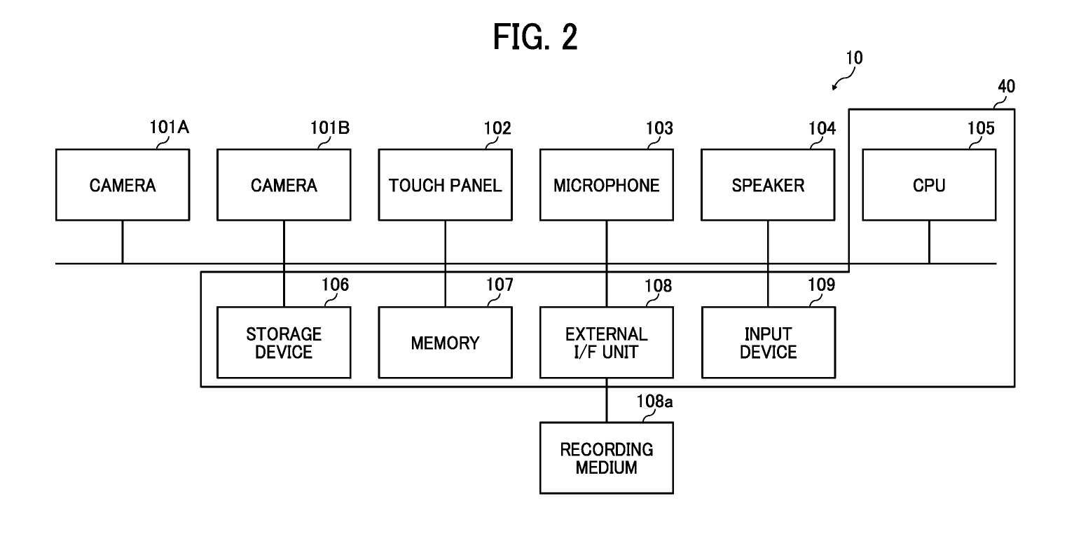

A hardware configuration of the IWB 10 according to the first embodiment will be described with reference to FIG. 2.

FIG. 2 is a diagram illustrating an example of the hardware configuration of the IWB according to the first embodiment. The IWB 10 includes the cameras 101A and 101B, the touch panel 102, a microphone 103, a speaker 104, and the image processing device 40. In the IWB 10, the image processing device 40 includes a central processing unit (CPU) 105, a storage device 106, a memory 107, an external interface (I/F) unit 108, and an input device 109.

Each of the cameras 101A and 101B captures a still or video image, and transmits the captured image to the CPU 105. For example, the cameras 101A and 101B are installed on the right side and the left side of the touch panel 102, respectively, and are positioned to have different optical axes, i.e., different viewpoints.

The touch panel 102 is, for example, a capacitance touch panel integrated with a display and having a hovering detecting function. The touch panel 102 transmits to the CPU 105 the coordinates of a point in the touch panel 102 touched by a pen or a finger of a user. The touch panel 102 further displays still or video image data of the videoconference at another site, which is received from the CPU 105.

The microphone 103 acquires sounds of participants of the videoconference, and transmits the acquired sounds to the CPU 105. The speaker 104 outputs audio data of the videoconference at the another site, which is received from the CPU 105.

The CPU 105 controls all devices of the IWB 10, and performs control related to the videoconference. Specifically, the CPU 105 encodes still or video image data, audio data, and rendering data synthesized from still or video images acquired from the cameras 101A and 101B, the microphone 103, and the touch panel 102, and transmits the encoded data to the other IWBs 10 via the external I/F unit 108.

The CPU 105 further decodes still or video image data, audio data, and rendering data received via the external I/F unit 108, displays the decoded still or video image data and rendering data on the touch panel 102, and outputs the decoded audio data to the speaker 104. The CPU 105 performs the above-described encoding and decoding in conformity with a standard such as H.264/Advanced Video Coding (AVC), H.264/Scalable Video Coding (SVC), or H.265. The encoding and decoding are executed with the CPU 105, the storage device 106, and the memory 107. Alternatively, the encoding and decoding may be executed through software processing with a graphics processing unit (GPU) or a digital signal processor (DSP) or through hardware processing with an application specific integrated circuit (ASIC) or a field programmable gate array (FPGA) to execute the encoding and decoding faster.

The storage device 106, which is a non-volatile storage medium such as a flash memory or a hard disk drive (HDD), for example, stores programs.

The memory 107, which is a volatile memory such as a double-data rate (DDR) memory, is used to deploy programs used by the CPU 105 and temporarily store arithmetic data.

The external I/F unit 108 is connected to the other IWBs 10 via the network N such as the Internet to transmit and receive image data and other data to and from the other IWBs 10. For example, the external I/F unit 108 performs communication with a wired LAN conforming to a standard such as 10 Base-T, 100 Base-TX, or 1000 Base-T or with a wireless LAN conforming to a standard such as 802.11a/b/g/n.

The external I/F unit 108 is an interface with an external device such as a recording medium 108a. The IWB 10 writes and reads data to and from the recording medium 108a via the external I/F unit 108. The recording medium 108a may be a flexible disk, a compact disc (CD), a digital versatile disc (DVD), a secure digital (SD) memory card, or a universal serial bus (USB), for example.

The input device 109, which includes a keyboard and buttons, receives an operation performed by the user to control a device of the IWB 10.

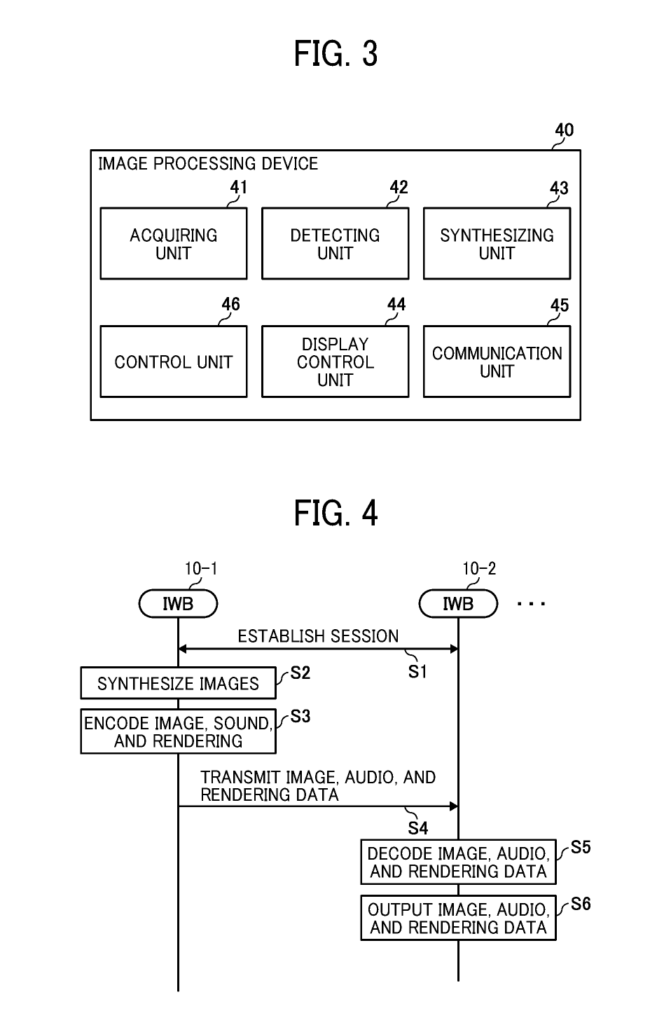

A functional configuration of the image processing device 40 of the IWB 10 according to the first embodiment will now be described with reference to FIG. 3.

FIG. 3 is a diagram illustrating an example of functional blocks of the image processing device 40 in the IWB 10 according to the first embodiment.

The image processing device 40 of the IWB 10 includes an acquiring unit 41, a detecting unit 42, a synthesizing unit 43, a display control unit 44, a communication unit 45, and a control unit 46. These units are implemented through processing of the CPU 105 of the image processing device 40 in the IWB 10 executed by at least one program installed in the image processing device 40.

The acquiring unit 41 acquires still or video images continuously captured by the cameras 101A and 101B from different viewpoints. The detecting unit 42 detects areas of the faces of persons in the images acquired by the acquiring unit 41.

The synthesizing unit 43 sets the position of a boundary in one of intervals between the areas of the faces of the persons in the image of the camera 101A detected by the detecting unit 42. The synthesizing unit 43 then combines a part of the image of the camera 101A and at least a part of the image of the camera 101B at the position of the boundary, to thereby synthesize an image which includes the areas of the faces of the persons in the image of the camera 101A and the areas of the faces of the persons in the image of the camera 101B without overlapping of the areas of the faces of the persons between the two images.

The control unit 46 encodes and decodes data such as image data, audio data, and rendering data, and controls the session of the videoconference with the other IWBs 10, for example.

The display control unit 44 displays data such as image data, audio data, and rendering data on the touch panel 102 of the IWB 10 in accordance with an instruction from the control unit 46.

The communication unit 45 communicates with the other IWBs 10. For example, the communication unit 45 transmits to the other IWBs 10 data such as image data synthesized by the synthesizing unit 43 and encoded by the control unit 46.

The processing of the communication system 1 according to the first embodiment will now be described with reference to FIG. 4.

FIG. 4 is a sequence chart illustrating an example of the processing of the communication system 1 according to the first embodiment.

In each of the IWBs 10 including the IWBs 10-1 and 10-2, the control unit 46 establishes a session with the other IWBs 10 in accordance with an operation performed by the user, for example (step S1). Thereby, the IWBs 10 start communication therebetween to transmit and receive therebetween still or video images, sounds, and renderings, for example.

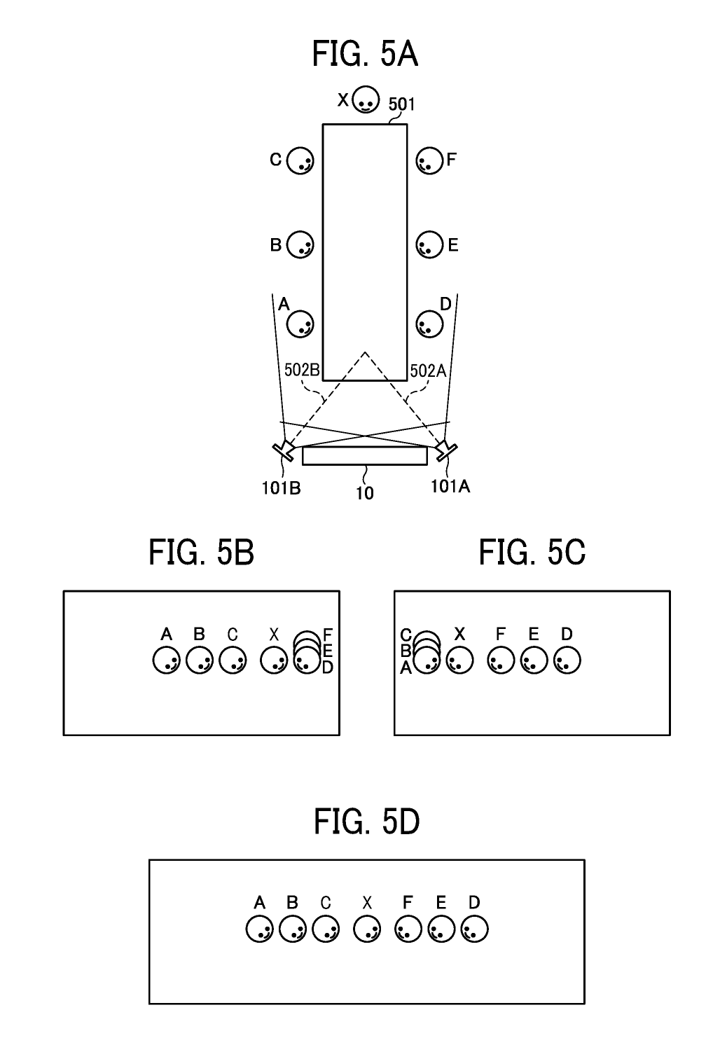

Then, the synthesizing unit 43 of the IWB 10-1 synthesizes the image captured by the camera 101A and the image captured by the camera 101B (step S2). FIGS. 5A to 5D are diagrams illustrating an image synthesizing process according to the first embodiment. FIG. 5A is a diagram illustrating an example of arrangement of the IWB 10 installed in a meeting space, as viewed immediately from above. In the example of FIG. 5A, a table 501 is placed in front of the IWB 10. On the left side of the table 501 as viewed from the IWB 10, persons A, B, and C are seated in this order from a side of the table 501 near the IWB 10. On the right side of the table 501 as viewed from the IWB 10, persons D, E, and F are seated in this order from the side of the table 501 near the IWB 10. A person X is seated at a side of the table 501 farthest from the IWB 10 to face the IWB 10.

The cameras 101A and 101B are installed on the right side and the left side of the panel unit 20 of the IWB 10, respectively, such that straight lines 502A and 502B cross each other at a predetermined position in front of the IWB 10. Herein, the straight line 502A is perpendicular to a lens surface of the camera 101A, and the straight line 502B is perpendicular to lens surface of the camera 101B.

As illustrated in FIG. 5B, the camera 101A captures the images of the faces of the persons A, B, C, and X from a substantially opposite side thereof without overlapping the faces of the persons A, B, C, and X. Further, the camera 101A obliquely captures the images of the faces of the persons D, E, and F such that the faces of the persons D, E, and F overlap.

Further, as illustrated in FIG. 5C, the camera 101B captures the images of the faces of the persons D, E, F, and X from a substantially opposite thereof without overlapping the faces of the persons D, E, F, and X. Further, the camera 101B obliquely captures the images of the faces of the persons A, B, and C such that the faces of the persons A, B, and C overlap.

With the process of step S2, the image captured by the camera 101A and the image captured by the camera 101B are synthesized to generate an image in which the faces of the persons A, B, C, D, E, F, and X do not overlap as viewed from a substantially opposite side thereto, as illustrated in FIG. 5D.

Then, in the IWB 10-1, the control unit 46 encodes the synthesized image, sound, and rendering (step S3), and the communication unit 45 transmits the encoded image data, audio data, and rendering data to the other IWBs 10 including the IWB 10-2 (step S4).

In the other IWBs 10 including the IWB 10-2, the control unit 46 decodes the image data, audio data, and rendering data received from the IWB 10-1 (step S5), and outputs the decoded image data, audio data, and rendering data (step S6).

The processes of steps S2 to S5 take place interactively between the IWBs 10 including the IWBs 10-1 and 10-2.

The process at step S2 of synthesizing the image captured by the camera 101A and the image captured by the camera 101B will now be described in more detail.

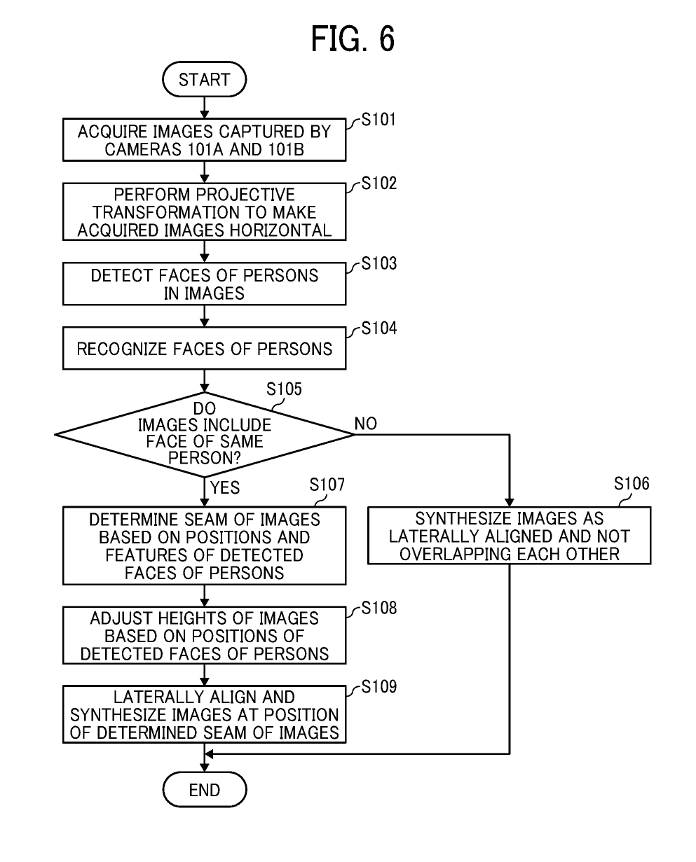

FIG. 6 is a flowchart illustrating an example of the image synthesizing process. At step S101, the acquiring unit 41 acquires the image captured by the camera 101A and the image captured by the camera 101B.

Then, the synthesizing unit 43 performs projective transformation on the acquired images to make the images horizontal (step S102). Herein, the synthesizing unit 43 detects straight lines in the images with Hough transformation, for example, and performs the projective transformation on the images to make the straight lines substantially horizontal. Alternatively, the synthesizing unit 43 may estimate the distance to a person based on the size of the face of the person detected at a later-described process of step S103, and may perform the projective transformation on the images with an angle according to the estimated distance.

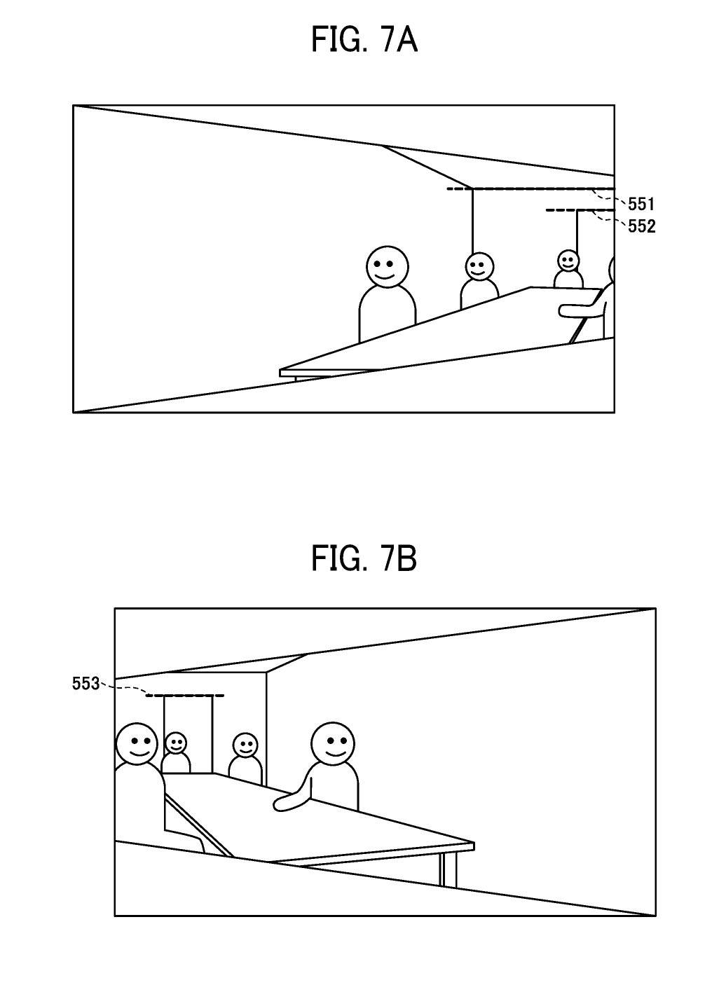

FIGS. 7A and 7B are diagrams illustrating the projective transformation process. At step S102, the synthesizing unit 43 detects, in each of the image captured by the camera 101A and the image captured by the camera 101B, a line such as a boundary line between a wall and a ceiling of a room or a boundary line between a wall and an upper part of a door of the room. The synthesizing unit 43 then performs the projective transformation on each of the images to make the detected boundary line substantially horizontal and thereby generate a trapezoidal image. FIG. 7A illustrates an example of the image captured by the camera 101A installed at the position thereof illustrated in FIG. 5A. FIG. 7B illustrates an example of the image captured by the camera 101B installed at the position thereof illustrated in FIG. 5A. In FIG. 7A, the projective transformation is performed such that a boundary line 551 between a wall and a ceiling of a room and a boundary line 552 between the wall and an upper part of a door in the room become horizontal. Further, in FIG. 7B, the projective transformation is performed such that a boundary line 553 between the wall and the upper part of the door of the room becomes horizontal. This projective transformation reduces unnaturalness of the image synthesized from the image captured by the camera 101A and the image captured by the camera 101B.

Then, the detecting unit 42 detects the faces of the persons in the images (step S103). The process of detecting the faces of the persons may be performed with an existing technique, such as a technique using Haar-like features, for example.

The detecting unit 42 then recognizes the faces of the persons detected in the images (step S104). The process of recognizing the faces of the persons may be performed with an existing technique. For example, the detecting unit 42 may detect relative positions and sizes of parts of the faces of the persons and the shapes of eyes, noses, cheek bones, and jaws of the persons as features to identify the persons.

Then, based on the positions and features of the faces of the persons detected by the detecting unit 42, the synthesizing unit 43 determines whether the images include the face of the same person (step S105). For example, the synthesizing unit 43 may compare the features of the faces of the persons detected in the image captured by the camera 101A with the features of the faces of the persons detected in the image captured by the camera 101B. Then, if the degree of similarity of the features reaches or exceeds a predetermined threshold for any of the faces of the persons, the synthesizing unit 43 may determine that the images include the face of the same person.

For example, in this case, the synthesizing unit 43 may first determine the degree of similarity of the features between the smallest faces in the images. Then, if the degree of similarity falls below the predetermined threshold, the synthesizing unit 43 may determine the degree of similarity of the features between the next smallest faces in the images. This configuration increases the speed of determining that the images include the face of the same person, if any.

If the images do not include the face of the same person (NO at step S105), the synthesizing unit 43 synthesizes the images as laterally aligned and not overlapping each other (step S106), and completes the process. For example, if the cameras 101A and 101B have a relatively narrow viewing angle, and if neither the image of the camera 101A nor the image of the camera 101B includes the detectable or recognizable face of the person X in FIG. 5A, the synthesizing unit 43 may determine not to synthesize the images in an overlapping manner.

If the images include the face of the same person (YES at step S105), the synthesizing unit 43 determines a seam of the images based on the positions and features of the faces of the persons detected by the detecting unit 42 (step S107). Herein, the seam is an example of the position of the boundary between the images. In this process, the synthesizing unit 43 determines, as the seam of the images, a position at which the faces of the same person do not overlap in the image synthesized from the laterally aligned images.

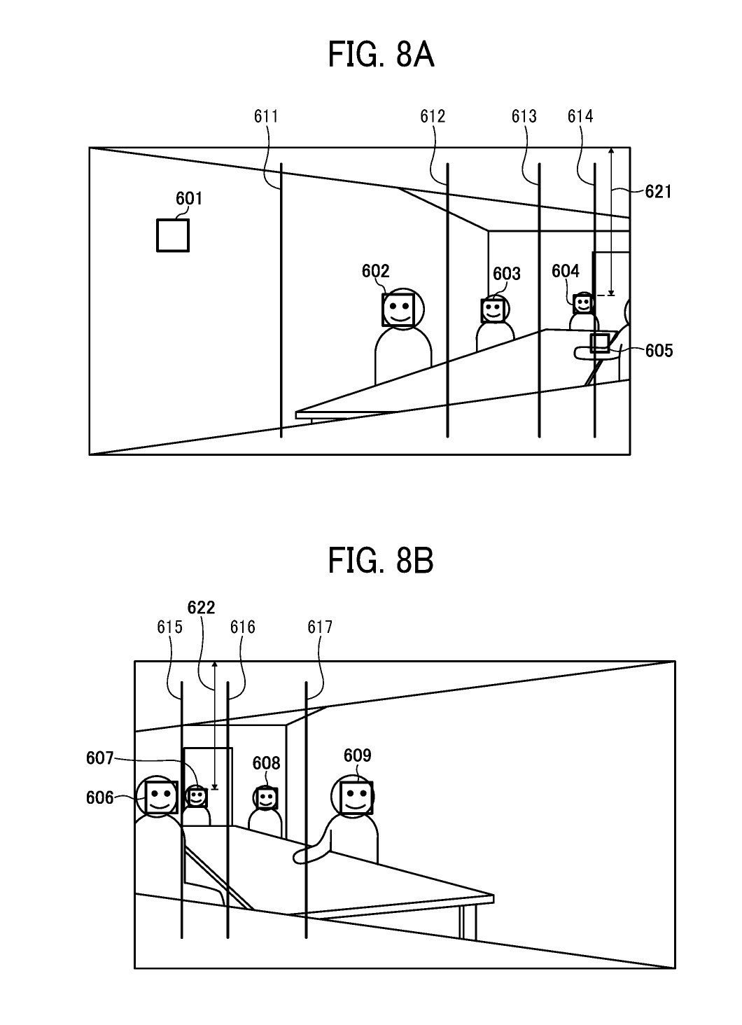

FIGS. 8A and 8B are diagrams illustrating the process of determining the seam of the images. As illustrated in FIGS. 8A and 8B, it is assumed that areas 601 to 609 are detected as faces in the images of FIGS. 7A and 7B. In this case, the synthesizing unit 43 calculates perpendiculars 611 to 617 between the areas 601 to 609 as candidates for the seam (hereinafter referred to as the seam candidates). Each of the seam candidates may be at an intermediate position between adjacent ends of the corresponding areas, or may be at an intermediate position between the respective centers of the corresponding areas. However, the seam candidate is not necessarily at the intermediate position, and may be at a given position between the corresponding areas. For example, in this case, the seam candidate may be at a position at which the respective widths of the images to be synthesized are most equal.

The area 601 includes a wall, but is erroneously detected to include a face. The area 605 includes an arm, but is erroneously detected to include a face. The synthesizing unit 43 averages face detection results of a plurality of frames (e.g., five frames in a video including frames per second) to reduce the influence of erroneous detection, i.e., to increase the signal-to-noise (S/N) ratio. For example, if an area is not detected as a face area at least a predetermined number of times in a predetermined number of frames, the synthesizing unit 43 determines the detection of the area as erroneous detection (i.e., noise), and does not use the result of this detection in the process at step S107 of determining the seam of the images.

The synthesizing unit 43 determines the seam from the seam candidates based on the positions and features of the faces of the persons.

In the example of FIGS. 8A and 8B, the degree of similarity of features based on facial recognition between the face of the person in the smallest area 604 in FIG. 8A and the face of the person in the smallest area 607 in FIG. 8B reaches the predetermined threshold. Thus, the synthesizing unit 43 determines that the areas 604 and 607 include the face of the same person. Therefore, the synthesizing unit 43 determines the seam at the position of the right end of the image in FIG. 8A and the position of the perpendicular 616 in the image of FIG. 8B to prevent overlapping of the faces of the person. Alternatively, the synthesizing unit 43 may determine the seam at the position of the perpendicular 613 in the image of FIG. 8A and the position of the perpendicular 615 in the image of FIG. 8B. In this case, the synthesizing unit 43 may determine the seam such that the resultant synthesized image includes the larger one of the area 604 in FIG. 8A and the area 607 in FIG. 8B determined to include the face of the same person. Thereby, the face of the person is displayed in a relatively large size on the other IWBs 10 for the participants of the videoconference at other sites.

The right end of the image in FIG. 8A may correspond to a position previously set as the right end in the image captured by the camera 101A. In this case, a portion of the image right of the thus-set right end is cut off.

As compared with a case in which the image of the camera 101A and the image of the camera 101B are synthesized at a seam set at a predetermined position without detection of the faces of the persons, the present configuration prevents the images of the face of a person captured from different viewpoints from being synthesized. Accordingly, a more natural, less artificial image is generated.

The synthesizing unit 43 then adjusts the respective heights of the images based on the detected position of the face of the person (step S108). In this step, the synthesizing unit 43 adjusts the respective heights of the images such that the respective smallest face areas detected in the images captured by the cameras 101A and 101B and determined to include the face of the same person have substantially the same height. In the example of FIGS. 8A and 8B, the synthesizing unit 43 adjusts the respective heights of the images such that a height 621 of the area 604 in FIG. 8A and a height 622 of the area 607 in FIG. 8B are the same.

The synthesizing unit 43 then combines the images as laterally aligned at the determined position of the seam of the images (step S109).

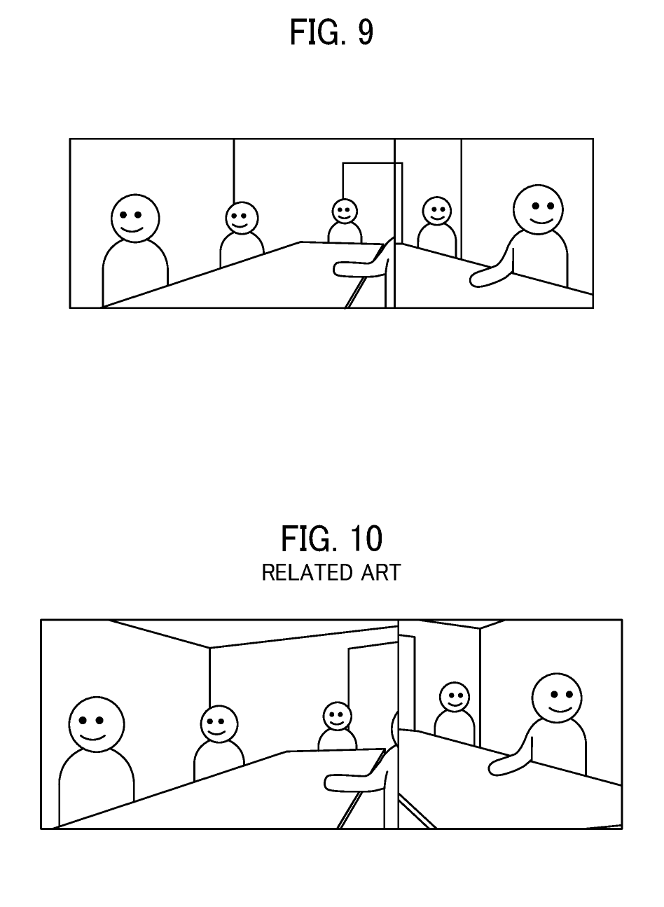

FIG. 9 is a diagram illustrating an example of the image synthesized from the laterally aligned images. In FIG. 9, the images are laterally aligned with the seam thereof set at the right end position in FIG. 8A and the position of the perpendicular 616 in FIG. 8B. In this example, the synthesizing unit 43 cuts off a portion of the image in FIG. 8B left of the seam (i.e., the perpendicular 616). If the seam is set to the position of the perpendicular 613 in FIG. 8A and the position of the perpendicular 615 in FIG. 8B, the synthesizing unit 43 cuts off a portion of the image in FIG. 8A right of the seam (i.e., the perpendicular 613), and cuts off a portion of the image in FIG. 8B left of the seam (i.e., the perpendicular 615).

The synthesizing unit 43 further cuts off upper and lower portions of the images not to display blank areas produced in the height direction owing to the projective transformation performed at step S102.

The synthesizing unit 43 further cuts off a portion of each of the images on the opposite side of the seam and not including a detected face area. In FIG. 9, a left portion of the image in FIG. 8A separated from the area 602 by at least a predetermined coordinate value and a right portion of the image in FIG. 8B separated from the area 609 by at least a predetermined coordinate value are cut off.

FIG. 10 is a diagram illustrating an example of an image synthesized from laterally aligned images not subjected to the projective transformation and the height adjustment. The image of a meeting room in FIG. 9 subjected to the projective transformation at step S102 and the height adjustment of the images at step S108 is more natural than the image of the meeting room not subjected to the projective transformation and the height adjustment, as illustrated in FIG. 10.

If the above-described processes at steps S103 to S107 in FIG. 6 for determining the seam of the images are performed for each of the frames of the video, the processing load is increased. Further, the seam changes in accordance with slight movements of the persons. Thus, performing these processes for each of the frames may make the still or video images uncomfortable to watch for viewers. The processes of steps S103 to S107 in FIG. 6 are therefore performed at a predetermined frequency, such as at predetermined time intervals (e.g., time unit intervals of once per approximately ten seconds to approximately thirty seconds or frame intervals of once per a few hundred frames). Alternatively, the processes of steps S103 to S107 may be performed when a person moves in or out of imaginable areas of the cameras 101A and 101B.

On the other hand, the processes of steps S101, S102, S108, and S109 in FIG. 6 are performed for each of the frames of videos captured by the cameras 101A and 101B. In this case, the synthesizing unit 43 performs the processes of steps S102, S108, and S109 with the calculation results of the seam position and so forth determined in the previous execution of the processes of steps S103 to S107.

If the image captured by the camera 101A and the image captured by the camera 101B are different in brightness owing to a factor such as lighting in the room or outside light, optical correction such brightness correction may be performed to reduce the difference in brightness between the images.

Further, if the seam position is changed, the seam may be moved from the previous seam position to the present seam position continuously (i.e., smoothly) not discretely.

Modified examples of the present embodiment will now be described.

A modified example of the process of determining the same person will first be described.

At step S107, the synthesizing unit 43 may determine, without the facial recognition by the detecting unit 42, that the respective smallest areas in the images detected as face areas include the face of the same person. For example, among the areas 602 to 604 correctly detected as face areas in the example of FIG. 8A, the leftmost area 602 is largest, and the area is reduced toward the right side, i.e., to the area 603 and then to the area 604.

Among the areas 606 to 609 detected as face areas in the example of FIG. 8B, the rightmost area 609 is largest, and the area is reduced toward the left side, i.e., to the area 608 and then to the area 607, and is increased in the leftmost area 606.

In this case, the synthesizing unit 43 determines that the smallest one of the areas detected as face areas in the image captured by the camera 101A and the smallest one of the areas detected as face areas in the image captured by the camera 101B include the face of the same person, and determines the seam of the images to be laterally aligned at a position not included in the area of the face of the person to prevent overlapping of the images of the person.

In the example of FIGS. 8A and 8B, the area 604 is smallest in FIG. 8A, and the area 607 is smallest in FIG. 8B. Therefore, the synthesizing unit 43 assumes that the areas 604 and 607 include the face of the same person, and determines the seam at the right end position in FIG. 8A and the position of the perpendicular 616 in FIG. 8B. Alternatively, the synthesizing unit 43 may determine the seam at the position of the perpendicular 613 in FIG. 8A and the position of the perpendicular 615 in FIG. 8B.

Further, the synthesizing unit 43 may determine the seam based on the distances of the intervals between the seam candidates instead of the results of the facial recognition or the sizes of the faces. That is, the synthesizing unit 43 may set the seam to the seam candidate corresponding to the shortest one of the intervals between the seam candidates. For instance, in the example of FIG. 8B, the synthesizing unit 43 may set the seam to the perpendicular 616, i.e., a seam candidate corresponding to the interval between the perpendiculars 615 and 615, which is the shortest one of the intervals between the seam candidates.

As another modified example of the present embodiment, if the detecting unit 42 detects the faces of persons only in one of the image captured by the camera 101A and the image captured by the camera 101B, the synthesizing unit 43 may transmit only the image including the detected faces of the persons to the other IWBs 10 for the participants of the videoconference at the other sites, without synthesizing the images. Then, if the faces of persons are detected in the other one of the images, the synthesizing unit 43 may synthesize the images through the above-described process of FIG. 6.

As another modified example of the present embodiment, the synthesizing unit 43 may synthesize an image from laterally aligned images captured by three or more cameras, instead of the laterally aligned images captured by the two cameras 101A and 101B. In this case, each of seams for combining the images may be set at a position in one of the intervals between the faces of the persons similarly as in the above-described example.

A second embodiment of the present invention will now be described.

In the above-described example of the first embodiment, the rectangular table 501 having short sides parallel to the IWB 10 is placed in front of the IWB 10. In the second embodiment, a description will be given of an example in which a substantially circular table is placed in front of the IWB 10. According to the second embodiment, the images are synthesized similarly as in the first embodiment when the participants of the videoconference are seated around the substantially circular table. The second embodiment is similar to the first embodiment except for some differences, and thus redundant description will be omitted as appropriate. The following description will focus on differences from the first embodiment, and description of parts similar to those of the first embodiment will be omitted.

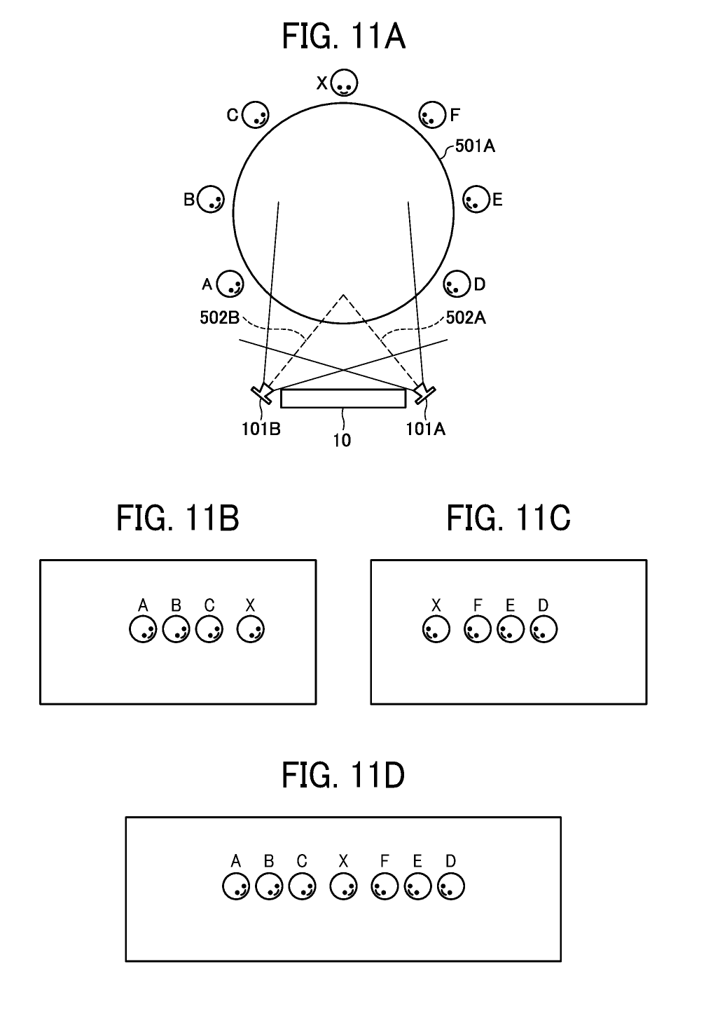

FIGS. 11A to 11D are diagrams illustrating an image synthesizing process according to the second embodiment. FIG. 11A is a diagram illustrating an example of arrangement of an IWB 10 installed in a meeting space, as viewed immediately from above. In the example of FIG. 11A, a substantially circular table 501A is placed in front of the IWB 10. On the left side of the table 501A as viewed from the IWB 10, the persons A, B, and C are seated in this order from a side of the table 501A near the IWB 10. On the right side of the table 501 as viewed from the IWB 10, the persons D, E, and F are seated in this order from the side of the table 501A near the IWB 10. The person X is seated at a side of the table 501A farthest from the IWB 10 to face the IWB 10.

As illustrated in FIG. 11B, the camera 101A captures the images of the faces of the person A, B, C, and X without overlapping the faces of the persons A, B, C, and X. Further, as illustrated in FIG. 11C, the camera 101B captures the images of the faces of the persons D, E, F, and X without overlapping the faces of the persons D, E, F, and X.

In this case, unlike in the first embodiment illustrated in FIG. 5A, the farthest person from the cameras 101A and 101B is not the person X. In the example of FIG. 11A, the persons B and C are farthest from the camera 101A, and the persons E and F are farthest from the camera 101B.

In the previous execution of the process of step S107 in FIG. 6, therefore, the synthesizing unit 43 of the second embodiment stores the positions of the areas in the images determined to include the face of the same person, instead of first determining the degree of similarity of the features between the smallest faces.

Then, in the present execution of the process of step S107 in FIG. 6, the synthesizing unit 43 of the second embodiment first selects faces closest to the stored positions from the areas of the faces of the persons detected in the images by the detecting unit 42 in the present execution of the process of step S103, and determines the degree of similarity of the features between the selected faces.

If the degree of similarity of the features between the faces closest to the stored positions falls below a predetermined threshold, the synthesizing unit 43 determines, for one of the remaining faces of the persons selected in a given order, whether the degree of similarity of the features between the face in one of the images and the face in the other one of the images equals or exceeds the predetermined value. If the images include the face of the same person, this configuration increases the speed of determining that the images include the face of the same person.

A third embodiment of the present invention will now be described.

In the above-described example of the first embodiment, the rectangular table 501 is placed in front of the IWB 10 with the short sides of the rectangular table 501 parallel to the IWB 10. In the third embodiment, a description will be given of an example in which a rectangular table is placed in front of the IWB 10 with long sides of the table parallel to the IWB 10. According to the third embodiment, the images are synthesized similarly as in the first embodiment when the participants of the videoconference are seated at the rectangular table to directly face the IWB 10. The third embodiment is similar the first or second embodiment except for some differences, and thus redundant description will be omitted as appropriate. The following description will focus on differences from the first or second embodiment, and description of parts similar to those of the first or second embodiment will be omitted.

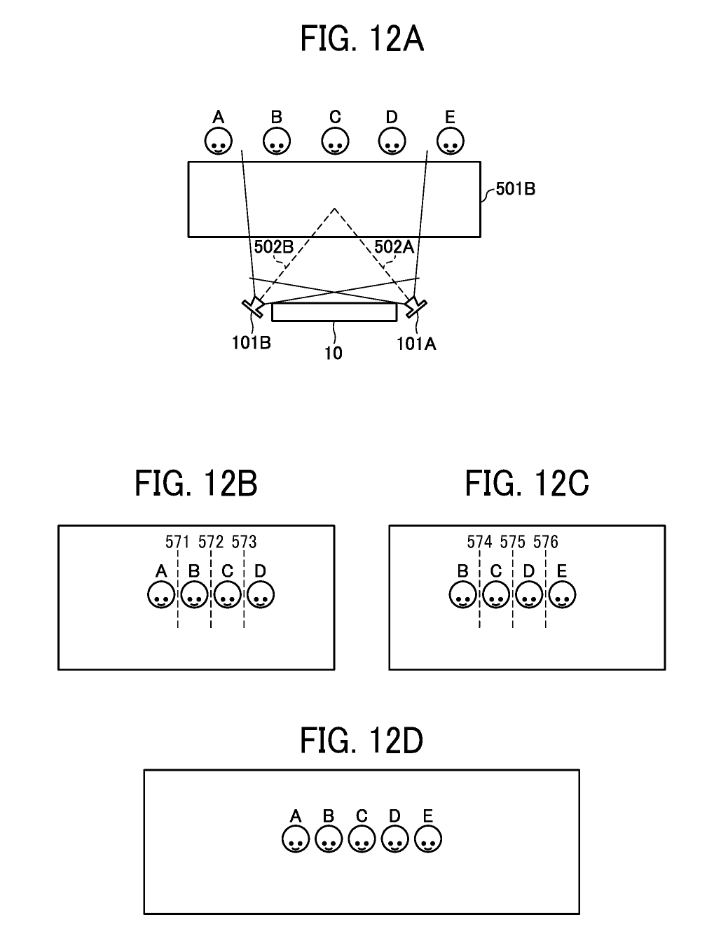

FIGS. 12A to 12D are diagrams illustrating an image synthesizing process according to the third embodiment. FIG. 12A is a diagram illustrating an example of arrangement of an IWB 10 installed in a meeting space, as viewed immediately from above. In the example of FIG. 12A, a rectangular table 501B is placed in front of the IWB 10 with long sides of the table 501B parallel to the IWB 10. The persons A to E are seated in this order from the left side of the table 501B as viewed from the IWB 10.

As illustrated in FIG. 12B, the camera 101A captures the images of the faces of the persons A to D without overlapping the faces of the persons A to D. Further, as illustrated in FIG. 12C, the camera 101B captures the images of the faces of the persons B to E without overlapping the faces of the persons B to E.

In the example of FIG. 12A, the person A is farthest from the camera 101A, and the person E is farthest from the camera 101B. Further, each of the image captured by the camera 101A and the image captured by the cameras 101B includes the areas of the faces of the persons B to D.

When the same plurality of persons are included in the images, the synchronizing unit 43 of the third embodiment determines the seam at a position between a person positioned at or near the center of the same plurality of persons and a person adjacent to the person positioned at or near the center.

In the example of FIGS. 12A to 12D, the synchronizing unit 43 sets the seam to a seam candidate 572 or 573 of seam candidates 571, 572, and 573 in FIG. 12B, which is close to the person C positioned at or near the center of the same plurality of persons B to D.

Further, the synchronizing unit 43 sets the seam of the images to one of seam candidates 574 and 575 of seam candidates 574, 575, and 576 in FIG. 12C, which is close to the person C positioned at or near the center of the same plurality of persons B to D, and which does not cause overlapping of the faces of the same person in the image synthesized from the laterally aligned images. That is, if the seam candidate 572 in FIG. 12B is set as the seam in one of the images, the seam candidate 574 in FIG. 12C is set as the seam in the other image.

In this case, the synchronizing unit 43 may determine the seam such that the synthesized image includes the larger one of an area in the one of the images determined to include the face of the person positioned at or near the center of the same plurality of persons and an area in the other image determined to include the face of the person positioned at or near the center of the same plurality of persons. This configuration increases the size of the face of the person displayed on the other IWBs 10 for the participants of the videoconference on the other sites.

A fourth embodiment of the present invention will now be described.

In the fourth embodiment, a description will be given of an example having a function of detecting a speaker with a plurality of microphones and displaying a zoomed-in image of the face of the speaker, as well as the functions of the first to third embodiments. The fourth embodiment is similar to the first to third embodiments except for some differences, and thus redundant description will be omitted as appropriate. The following description will focus on differences from the first to third embodiments, and description of parts similar to those of the first to third embodiments will be omitted.

A hardware configuration of an IWB 10B according to the fourth embodiment will be described.

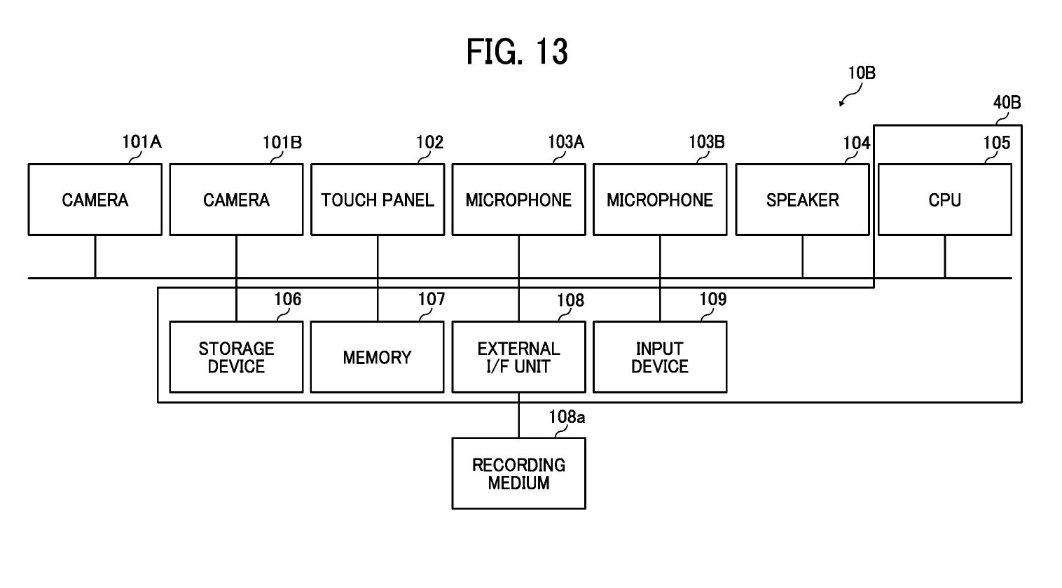

FIG. 13 is a diagram illustrating an example of the hardware configuration of the IWB 10B according to the fourth embodiment. The IWB 10B according to the fourth embodiment includes microphones 103A and 103B in place of the microphone 103 according to the first embodiment. The microphones 103A and 103B are installed near the cameras 101A and 101B, respectively, for example.

A functional configuration of an image processing device 40B of the IWB 10B according to the fourth embodiment will be described.

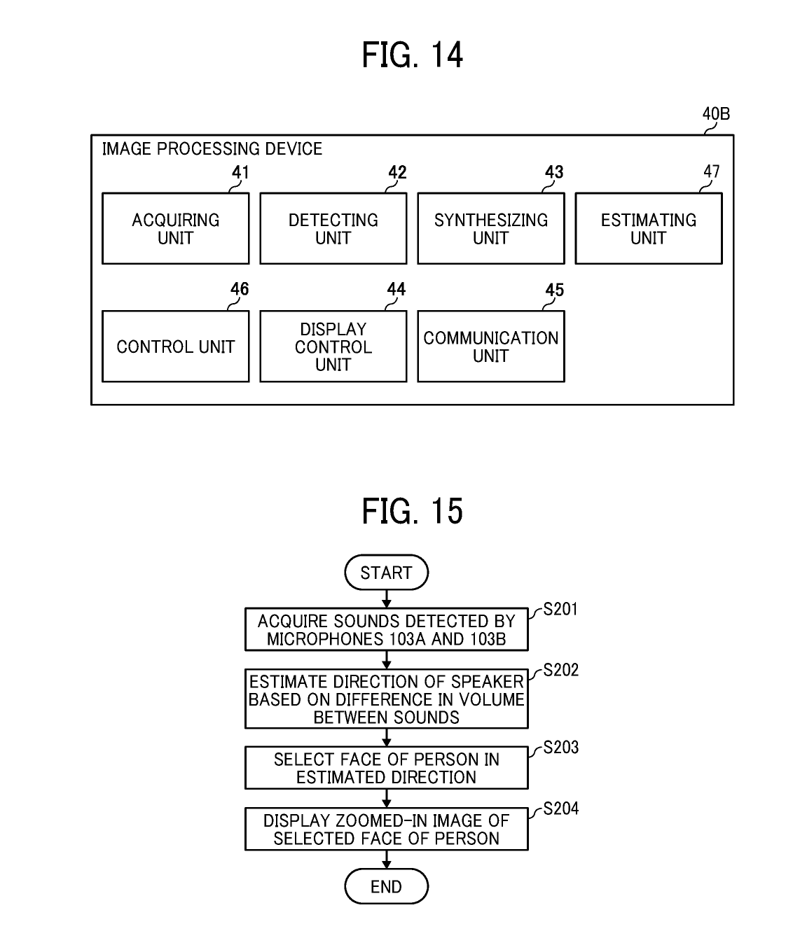

FIG. 14 is a diagram illustrating an example of functional blocks of the image processing device 40B of the IWB 10B according to the fourth embodiment. The image processing device 40B according to the fourth embodiment further includes an estimating unit 47. The estimating unit 47 is implemented through processing of the CPU 105 of the image processing device 40B in the IWB 10B executed by at least one program installed in the image processing device 40B. The estimating unit 47 estimates the direction of the speaker.

The acquiring unit 41 according to the fourth embodiment further acquires sounds collected by the microphones 103A and 103B.

The synthesizing unit 43 according to the fourth embodiment further enlarges an area according to the direction of the speaker estimated by the estimating unit 47, and generates a synthesized image by superimposing the enlarged area on a lower-central part of the synthesized image.

A process of displaying the zoomed-in image of the speaker according to the fourth embodiment will be described.

FIG. 15 is a flowchart illustrating an example of the process of displaying the zoomed-in image of the speaker according to the fourth embodiment. At step S201, the acquiring unit 41 acquires sounds detected by the microphones 103A and 103B. Then, the estimating unit 47 estimates the direction of the speaker based on the difference in volume between the sound detected by the microphone 103A and the sound detected by the microphone 103B (step S202).

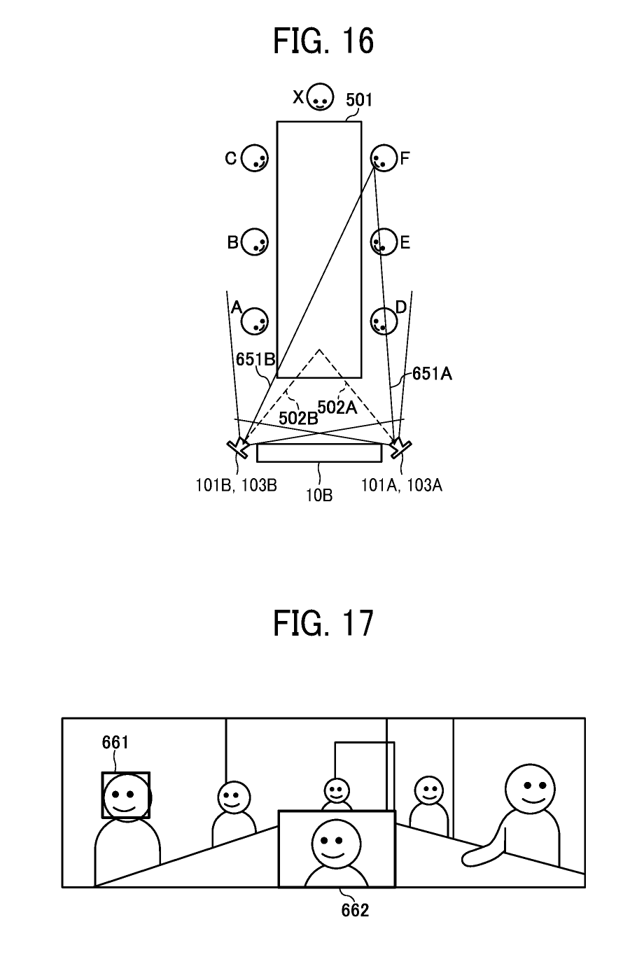

FIG. 16 is a diagram illustrating a process of estimating the direction of the speaker. As illustrated in FIG. 16, the volume of the sound from the speaker (i.e., the person F in this example) attenuates in accordance with the distance to the speaker (i.e., distance 651A or 651B). Thus, there is a difference in volume between the sound detected by the microphone 103A and the sound detected by the microphone 103B. Based on this difference in volume, the estimating unit 47 estimates the direction of the speaker as a sound source.

Then, the synchronizing unit 43 selects the face of the person in the estimated direction from the faces detected by the cameras 101A and 101B (step S203). In this step, the synthesizing unit 43 compares the direction of the speaker with the directions of the faces detected by the cameras 101A and 101B, to thereby identify the area of the face of the speaker. The direction of each of the faces may be calculated based on the size of the area of the detected face and coordinates of the area of the face in the image, for example. The synthesizing unit 43 then displays a zoomed-in image of the selected face of the person (step S204).

FIG. 17 is a diagram illustrating an example of a screen displaying the zoomed-in image of the speaker. The synthesizing unit 43 synthesizes the image of the camera 101A and the image of the camera 101B in a similar manner as in the first to third embodiments, and then displays a zoomed-in image of an area 662, which includes an area 661 of the face of the speaker, in a lower-central part of the synthesized image, for example. Thereby, the zoomed-in image of the speaker is displayed in a part of the image synthesized from the image of the camera 101A and the image of the camera 101B, in which the table 501 is displayed as if divided, as illustrated in FIG. 9.

If it is difficult to identify the speaker when the participants of the videoconference are close to each other, for example, the synthesizing unit 43 may display a zoomed-in image of an area including the faces of a few people in the direction of the sound source detected by the microphones 103A and 103B.

A fifth embodiment of the present invention will be described.

In the above-described example of the first embodiment, the images of the two cameras 101A and 101B installed on the right and left sides of the IWB 10 are aligned and synthesized. In the fifth embodiment, a description will be given of an example in which, in addition to the functions of the first to third embodiments, another camera is provided on an upper part of the IWB 10 to switch between the image of the another camera and the image synthesized from the aligned images of the two cameras 101A and 101B installed on the right and left sides of the IWB 10.

The fifth embodiment is similar to the first to third embodiments except for some differences, and thus redundant description will be omitted as appropriate. The following description will focus on differences from the first to third embodiments, and description of parts similar to those of the first to third embodiments will be omitted.

A hardware configuration of an IWB 10C according to the fifth embodiment will be described.

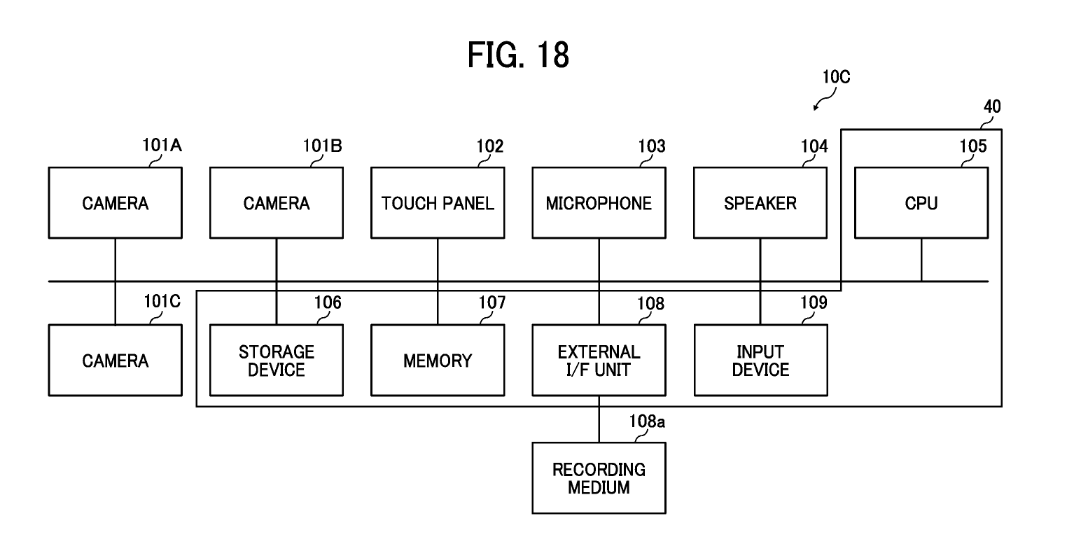

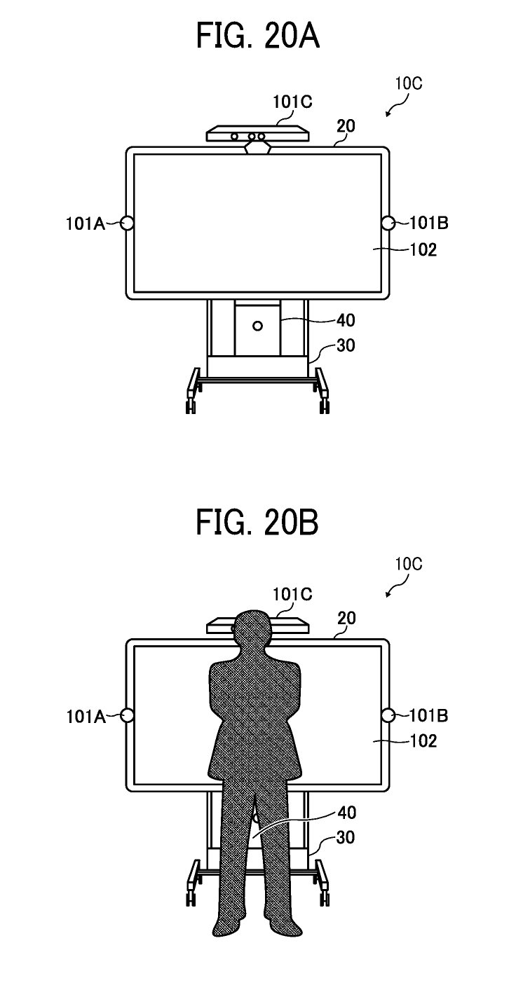

FIG. 18 is a diagram illustrating an example of the hardware configuration of the IWB 10C according to the fifth embodiment. The IWB 10C according to the fifth embodiment further includes a camera 101C, which is installed at a position above the touch panel 102, as illustrated in FIG. 20A, for example.

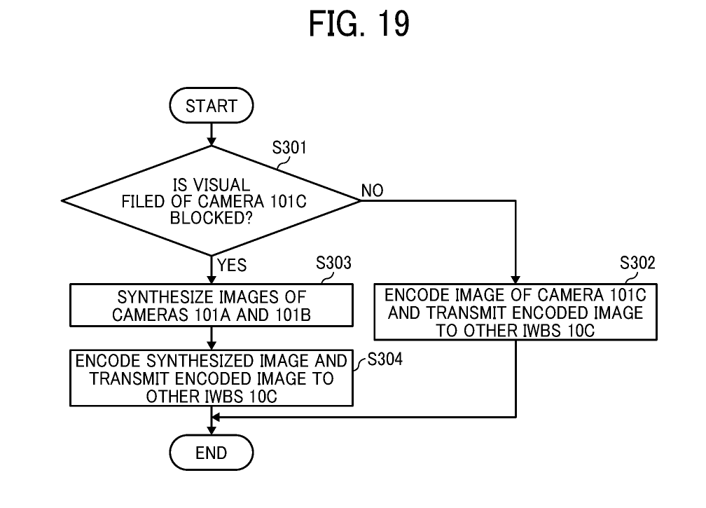

FIG. 19 is a flowchart illustrating an example of an image switching process according to the fifth embodiment. At step S301, the synthesizing unit 43 determines whether the visual field of the camera 101C is blocked by something, such as a person performing a handwriting input operation on the IWB 10C, for example. For instance, the synthesizing unit 43 may determine that the visual field of the camera 101C is blocked if the sum of luminance values of all pixels in the image of the camera 101C equals or falls below a predetermined threshold.

If the visual field of the camera 101C is not blocked (NO at step S301), the control unit 46 encodes the image of the camera 101C, and transmits the encoded image to the other IWBs 10C (step S302). Thereby, the process is completed.

FIGS. 20A and 20B are diagrams illustrating a process of switching the image to be transmitted. If the visual fields of the cameras 101A to 101C are not blocked, as illustrated in FIG. 20A, the image of the camera 101C is used.

If the visual field of the camera 101C is blocked (YES at step S301), the synthesizing unit 43 synthesizes the images of the cameras 101A and 101B (step S303). The image synthesizing process of step S303 is similar to the image synthesizing process of the first to third embodiments illustrated in FIG. 6.

If the visual field of the camera 101C is blocked, as illustrated in FIG. 20B, the synthesizing unit 43 uses the images of the cameras 101A and 101B. If the visual field of the camera 101A is blocked, for example, the synthesizing unit 43 may synthesize the images of the cameras 101B and 101C. Then, the control unit 46 encodes the synthesized image, and transmits the encoded image to the other IWBs 10C (step S304). Thereby, the process is completed.

As a modified example of the fifth embodiment, the synthesizing unit 43 may synthesize the images of the cameras 101A, 101B, and 101C if none of the visual fields of the cameras 101A, 101B, and 101C is blocked.

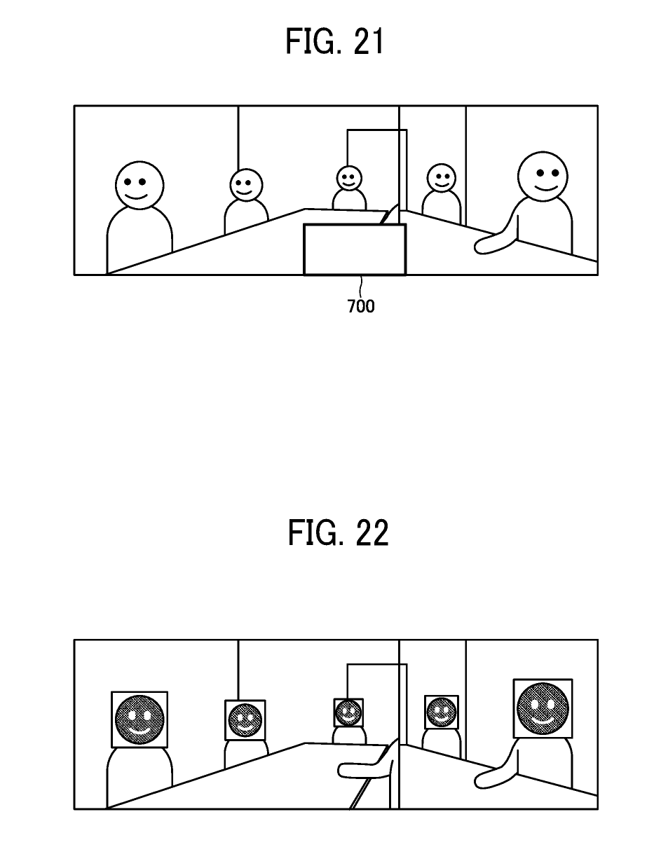

FIG. 21 is a diagram illustrating an example of synthesizing the images of the three cameras 101A, 101B, and 101C. As illustrated in FIG. 21, the synthesizing unit 43 may synthesize the images such that an area 700 corresponding to a lower-central part of the image of the camera 101C is superimposed on a lower-central part of the image synthesized from the images of the cameras 101A and 101B, for example. Thereby, the image of the table 501 included in the image of the camera 101C is displayed in a part of the image synthesized from the images of the cameras 101A and 101B, in which the table 501 is displayed as if divided, as illustrated in FIG. 9.

The camera 101C may be a multifunction camera, such as Kinect (registered trademark), for example, which acquires depth information indicating the distance to a person by using a device such as an infrared sensor and detects a sound direction indicating the direction of the speaker. In this case, the synthesizing unit 43 may use the sound direction acquired from the camera 101C (i.e., the multifunction camera) to display the zoomed-in image of the speaker similarly as in the second embodiment. Further, in this case, the synthesizing unit 43 may use the depth information acquired from the camera 101C to adjust the heights of the images at step S108. Thereby, the heights of the images are more accurately adjusted.

According to at least one of the first to fifth embodiments described above, the situation of the participants of the videoconference is well communicated.

As a modified example of the first to fifth embodiments, the synthesizing unit 43 may synthesize predetermined images, for example, into the detected face areas. FIG. 22 is a diagram illustrating an example of synthesizing predetermined images into the detected face areas. As illustrated in FIG. 22, when it is desirable not to display the faces of the participants of the videoconference, the synthesizing unit 43 may insert preset icons (i.e., pictorial faces) in the detected face areas. Alternatively, the synthesizing unit 43 may blot out the detected face areas, or may insert text information of previously registered names in the detected face areas.

According to the first to fifth embodiments described above, the faces of persons are detected in a plurality of images captured from different viewpoints, and the images are laterally aligned and synthesized with a seam thereof set in one of intervals between the faces of the persons detected in at least one of the images.

With this configuration, even if the participants of a videoconference spread over a relatively wide viewing angle as viewed from an electronic information board system (i.e., IWB 10, 10B, or 10C), for example, a natural image of the videoconference is communicated to another electronic information board system like an image of the videoconference captured by a single camera.

Further, for example, the images of the participants of the videoconference are captured from different viewpoints (i.e., different positions and angles) by a plurality of cameras. Therefore, the images of the participants are captured from the opposite side of the participants, as compared with a case in which the images of the participants are captured by a single camera. Further, the visual fields of the cameras are less likely to be completely blocked by something, such as the body of a person performing rendering on the board of the electronic information board system, than in a case in which the images of the participants of the videoconference are captured by a single camera installed on an upper-central part of the board.

In the IWB 10, 10B, or 10C, the functional units of the image processing device 40 or 40B, such as the detecting unit 42 and the synthesizing unit 43, for example, may be implemented by cloud computing using at least one computer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Further, the above-described steps are not limited to the order disclosed herein.

1. An image processing device comprising:
circuitry to
acquire a first image and a second image captured from different viewpoints,
detect areas of faces of a plurality of persons in the first image and the second image,
set a position of a boundary between the first image and the second image in one of intervals between the detected areas of the faces of the plurality of persons, and
combine the first image and the second image at the position of the boundary.

2. The image processing device of claim 1, wherein the circuitry combines the first image and the second image without overlapping the areas of the faces of the plurality of persons in the first image and the areas of the faces of the plurality of persons in the second image.

3. The image processing device of claim 2, wherein the circuitry
recognizes the faces of the plurality of persons, and
identifies, based on the recognized faces of the plurality of persons, the areas of the faces of the plurality of persons in the first image and the areas of the faces of the plurality of persons in the second image.

4. The image processing device of claim 1, wherein when the faces of the plurality of persons in the first image are different from the faces of the plurality of persons in the second image, the circuitry aligns and combines the first image and the second image without overlapping the first image and the second image.

5. The image processing device of claim 1, wherein the circuitry sets the position of the boundary in an interval between a smallest area of the areas of the faces of the plurality of persons in the first image and an area adjacent to the smallest area.

6. The image processing device of claim 1, wherein the circuitry
acquires the first image and the second image as images forming a video, and
synthesizes the first image and the second image at predetermined intervals with respect to frames of the video.

7. The image processing device of claim 1, wherein the circuitry adjusts at least one of a height of at least a part of the first image and a height of at least a part of the second image so as to make at least one of the areas of the faces of the plurality of persons equal in height between the first image and the second image when the first image and the second image are synthesized.

8. The image processing device of claim 1, wherein the circuitry corrects the first image and the second image to reduce a difference between a tilt of a background of the first image and a tilt of a background of the second image.

9. An electronic information board system comprising:
a board;
a first camera to capture a first image of a space in front of the board from a first viewpoint;
a second camera to capture a second image of the space in front of the board from a second viewpoint different from the first viewpoint; and
the image processing device of claim 1.

10. An electronic information board system comprising:
a board;
a first camera to capture a first image of a space in front of the board from a first viewpoint;
a second camera to capture a second image of the space in front of the board from a second viewpoint different from the first viewpoint; and
at least one processor to
acquire the first image and the second image,
detect areas of faces of a plurality of persons in the first image and the second image,
set a position of a boundary between the first image and the second image in one of intervals between the detected areas of the faces of the plurality of persons, and
combine the first image and the second image at the position of the boundary.

11. An image processing method comprising:
acquiring a first image and a second image captured from different viewpoints;
detecting areas of faces of a plurality of persons in the first image and the second image;
setting a position of a boundary between the first image and the second image in one of intervals between the detected areas of the faces of the plurality of persons; and
combining the first image and the second image at the position of the boundary.
